(19) United States
(12) Patent Application Publication
(10) Pub. No.: US 2004/0089164 A1
(43) Pub. Date: May 13, 2004

(54) Device that modifies irrigation schedules of existing irrgation controllers

(76) Inventors: John W. Addink, Riverside, CA (US); Sylvan Addink, Riverside, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/472,429

(22) PCT Filed: Nov. 6, 2001
(86) PCT No.: PCT/US01/46728

(51) Int. Cl. A01J 11/00

(52) U.S. Cl. 99/468

(57) ABSTRACT

A microprocessor (220), disposed in an irrigation controller (200), is programmed to automatically derive an irrigation schedule based at least in part on a rolling-average of required watering amounts. The rolling-average is preferably an average of four consecutive required watering amounts but may be more or less than four. Preferably the irrigation schedule and required watering amount are at least partly derived from ETo data. The ETo data may include potential ETo data, estimated ETo data, or historical ETo data.

### FIELD OF THE INVENTION

The field of the invention is irrigation controllers.

### BACKGROUND OF THE INVENTION

Many irrigation systems have been developed that automatically control the application of water to landscapes. These irrigation systems can range from simple systems that vary irrigation on a timed control basis, to very complex systems that vary irrigation based on climatic, geographic, and seasonal conditions. The complex systems can rely on various sources for data, including sensors and other devices that generate data locally, as well as governmental or commercial providers of information.

Complex controllers are known that make relatively frequent automatic compensations based on evapotranspiration data. Evapotranspiration is the water lost by direct evaporation from the soil and plant and by transpiration from the plant surface. Potential evapotranspiration (ETo) is calculated from meteorological data. ETo calculations are closely correlated to the water requirements of plants. Irrigation controllers that derive all or part of their irrigation schedule from potential ETo data are discussed in U.S. Pat. No. 5,479,339 issued December 1995, to Miller, U.S. Pat. No. 5,097,861 issued March 1992 to Hopkins, et al., U.S. Pat. No. 5,023,787 issued June 1991 and U.S. Pat. No. 5,229,937 issued July 1993 both to Evelyn-Veere, U.S. Pat. No. 5,208,855, issued May 1993, to Marian, U.S. Pat. No. 5,696,671, issued December 1997, and U.S. Pat. No. 5,870,302, issued February 1999, both to Oliver and U.S. Pat. No. 6,102,061, issued August, 2000 to Addink.

In addition, to basing irrigation schedules on ETo calculations, some controllers base irrigations on temperature, soil moisture and/or other weather factors. Regardless of the mechanism(s) used to determine changes in environmental conditions, most of the known systems are directed to replacement of moisture removed from the soil between the currently scheduled watering and the last previous watering. Thus, if the irrigation system is set to water daily, and on a certain day the ETo is determined to be 0.20 inches, then the following day the irrigation system would apply 0.20 inches of water. If the system were set for every other day watering, and the ETo was determined to be 0.35 inches on the day following the day with 0.20 inches then the next irrigation application would apply 0.55 inches of water.

It is not, however, always advantageous to apply, in a single application, the required amount of water to replace the water removed from the soil by evapotranspiration. The application of extremely high watering amounts, by many irrigation systems, on any one given day could put a strain on the water distribution capabilities of a local water supply system. Therefore, it is generally desirable to eliminate the extremely high irrigation watering amounts thereby reducing the potential of creating high peak water demands that the local water supply systems can't meet.

Most irrigation controllers that base applications on ETo data apply whatever the ETo readings were for the previous day(s) since the last application. For example, if on Tuesday the ETo data indicated that 0.20 inches of moisture was removed from the soil then on Wednesday the irrigation system would apply 0.20 inches of water to the landscape. However, U.S. Pat. No. 5,208,855 discusses an ET controller that bases the scheduled irrigation applications on an average of the previous weeks ETo data. This generally reduces the potential of high water applications being applied on any one given day but may result in irrigations that do not meet the water requirements of the plants. This is especially true, if a cool, wet week is followed by an extremely hot, dry week. The ETo data from the cool, wet week would result in low amounts of water being applied during the following week when it was hot and dry. This would likely result in the plants being under watered during the hot, dry week and could result in loss or damage to the plants.

What is needed is some method to reduce the high irrigation watering applications that are likely to occur following days of extremely hot, dry weather and yet still meet the water requirements of the plants with very little waste of water.

### SUMMARY OF THE INVENTION

The present invention provides systems and methods in which a microprocessor is programmed to automatically derive an irrigation schedule based at least in part on a rolling-average of required watering amounts.

Preferably a rolling-average is an average of four consecutive required watering amounts. Alternatively, a rolling-average may be some number of consecutive required watering amounts less than or more than four. Additionally, the rolling-average may be a weighted rolling average with greater emphasis put on some days than on other days.

Preferably an irrigation schedule and required watering amounts are at least partly derived from ETo data. ETo data may include potential ETo data, estimated ETo data, or historical ETo data. There is additional data that may be used in the derivation of the irrigation schedule and required watering amounts, such as, crop coefficient data and irrigation distribution uniformity data.

Various objects, features, aspects, and advantages of the present invention will become more apparent from the following detailed description that describes a preferred embodiment of the invention, along with the accompanying drawings in which like numerals represent like components.

### BRIEF DESCRIPTION OF THE DRAWINGS

FIG. 1 is a schematic of an irrigation controller according to an aspect of the present invention.

FIG. 2 is a block diagram of an irrigation system according to an aspect of the present invention.

FIG. 3 is a graphical representation of yearly irrigation applications according to an aspect of the present invention.

FIG. 4 is data that illustrates irrigation application durations based upon a rolling-average.

### DETAILED DESCRIPTION

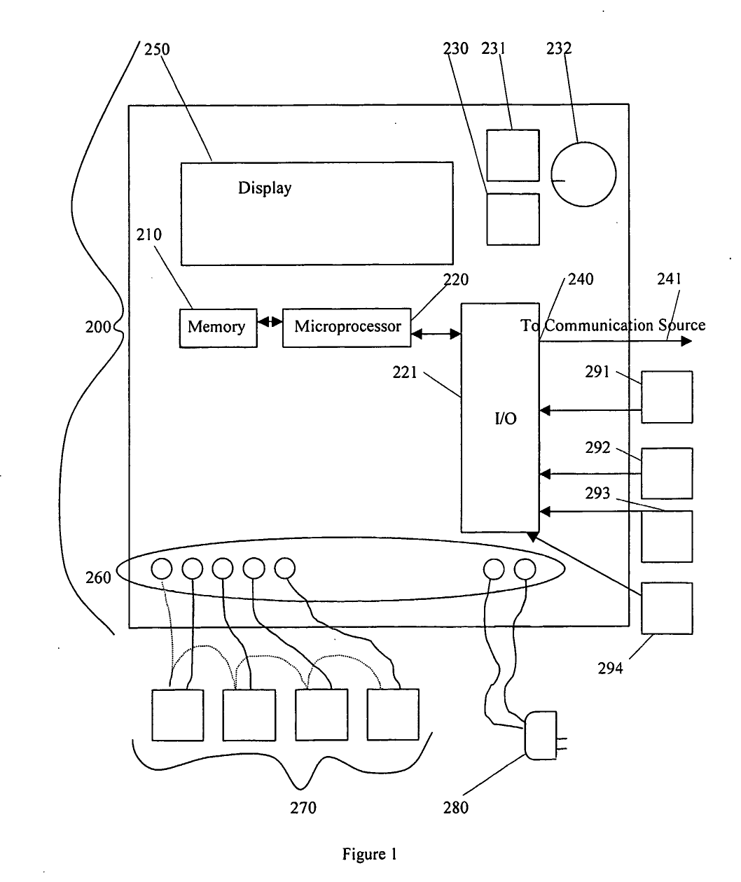

FIG. 1 is a schematic of an irrigation controller 200 according to the present invention that generally includes a microprocessor 220, an on-board memory 210, some manual input devices 230 through 232 (buttons and/or knobs), an input/output (I/O) circuitry 221 connected in a conventional manner, a display screen 250, a communications port 240, a serial, parallel or other communications connection 241 coupling the irrigation controller to one or more communication sources, electrical connectors 260 which are connected to a plurality of irrigation stations 270 and a power supply 280, a rain detection device 291, a flow sensor 292, a pressure sensor 293 and a temperature sensor 294. Each of these components by itself is well known in the electronic industry, with the exception of the programming of the microprocessor in accordance with the functionality set forth herein. There are hundreds of suitable chips that can be used for this purpose. At present, experimental versions have been made using a generic Intel 80C54 chip, and it is contemplated that such a chip would be satisfactory for production models.

In a preferred embodiment, the controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with personal computers, peripheral devices, and measurement equipment including but not limited to utility meters, water pressure sensors, and temperature sensors.

It is contemplated that the microprocessor will be disposed in an irrigation controller. Generally, the irrigation controller will be a standalone device such as a residential irrigation controller. Alternatively, the microprocessor may be disposed in a personal computer or other device that provides control of an irrigation system. With agricultural irrigation systems the irrigation system is generally controlled by a microprocessor disposed in a personal computer rather than a typical residential type irrigation controller. This also occurs with large irrigation systems, commercial systems, etc. where the microprocessor that provides some or all of the control of the irrigation system is disposed in a personal computer.

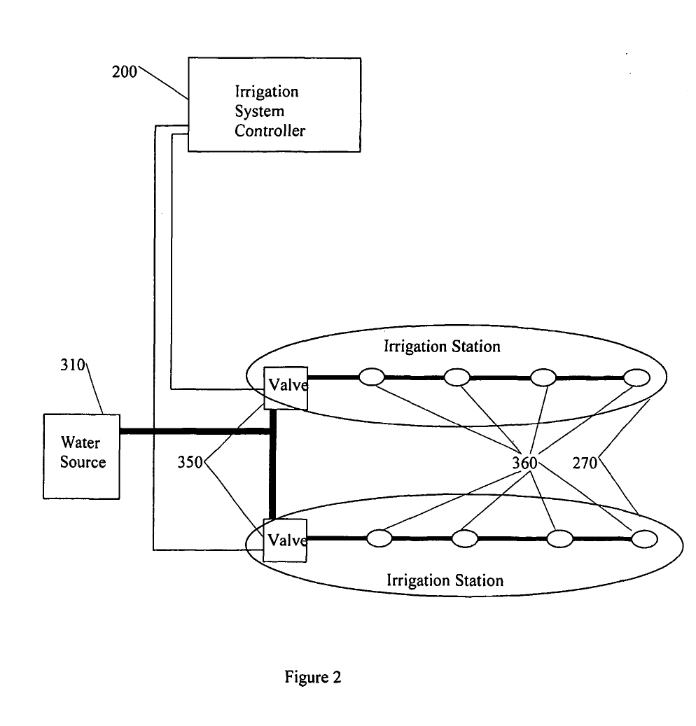

In FIG. 2 a single irrigation controller 200 operates two irrigation stations 270. It will be understood that these stations 270 are indicative of any two or more irrigation stations, and are not to be interpreted as limiting the number or configuration of irrigation stations. It is contemplated that the irrigation stations may be part of an underground installed irrigation system, such as those used on residential sites, commercial sites, golf courses, public parks, and so forth. Additionally the irrigation stations may be part of center pivot systems, wheel type systems, solid set systems, or any other irrigation system used in the irrigating of plants. Structure and operation of the irrigation controller is preferably as described elsewhere herein except as to the adjustment of the irrigation application according to the condition of the plants being irrigated. Among other things, the irrigation controller 200 operates solenoids (not shown) that open the station valves 350 to allow irrigation water from the water source 310 to be distributed to the various irrigation stations 270 and thereby irrigate the landscape through one or more (four are shown for each irrigation station but it may be any number) irrigation sprinkler heads 360.

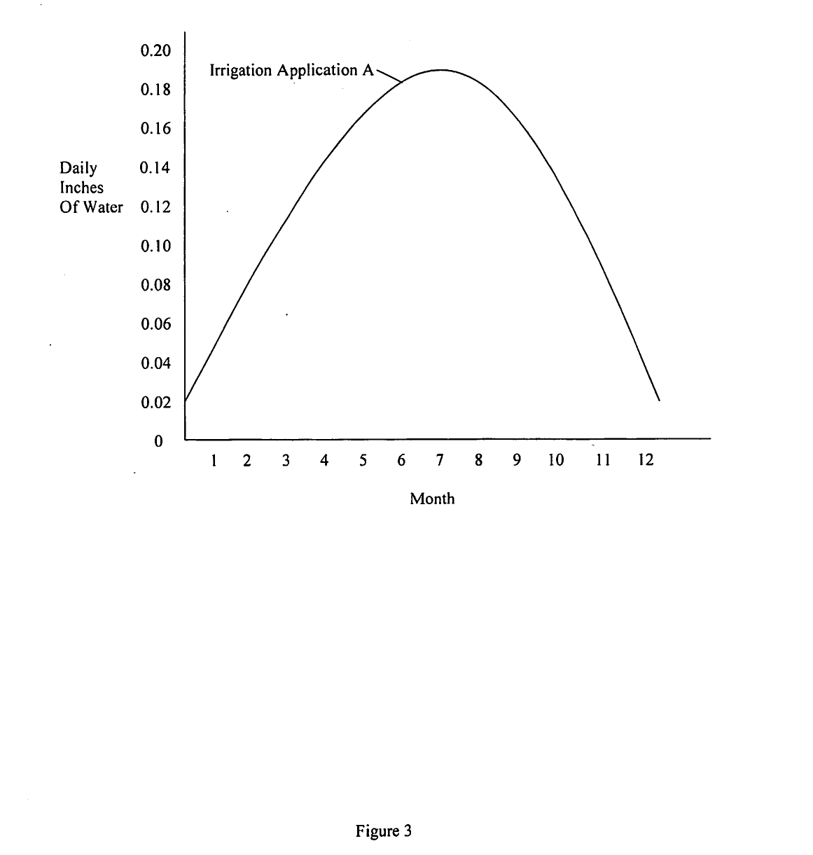

It is contemplated that when the irrigation controller is initially installed, an initial irrigation schedule will be programmed into the controller and stored in the memory. For example, if the irrigated site is a lawn the initial irrigation schedule for the summer may provide that each station apply a cycle amount of 0.19 inches of water with a frequency of seven days a week. During the ensuing year, the system automatically modifies the cycle amounts to provide the average cycle amounts depicted in FIG. 3, Irrigation Application A. From time to time manual changes can also be made to fine-tune the schedule, which would alter the height or shape of the curve.

Irrigation Application A is preferably at least partly derived from ETo data. ETo data is thought to closely approximate the water needs of the plants with a minimum waste of water. The ETo data used may advantageously comprise current ETo (i.e., within the last week, three days, or most preferably within the last 24 hours) designated as the required watering amount. The current ETo may be a potential ETo value that is calculated from the four weather factors; solar radiation, temperature, wind and relative humidity. Alternatively, the current ETo may be an estimated ETo value (as for example that described in pending US patent application serial no. PCTIUS00/18705) based upon a regression model using one or more of the factors used in calculating potential ETo. The ETo may also comprise an historical ETo value (as for example that described in pending US patent application serial no. PCT/US00/40685).

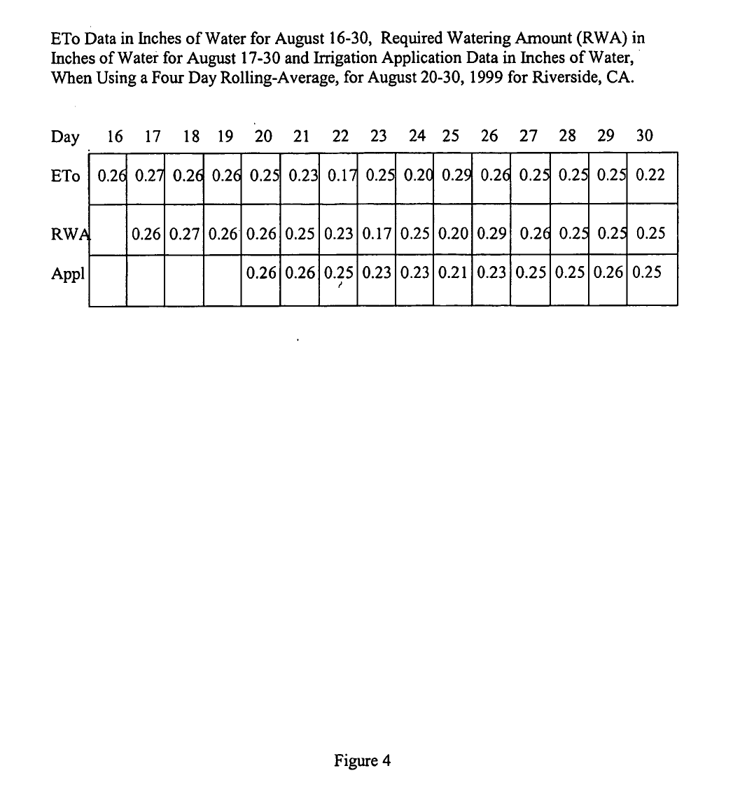

If Irrigation Application A were allowed to be applied based on the previous days ETo readings, as occurs with most prior art ET controllers, on some days the application amounts could be extremely high. However, in a preferred embodiment of the present invention the microprocessor (See FIG. 1, 220) is advantageously programmed to automatically use a rolling average to determine the irrigation application. This eliminates the likelihood that there will ever be extremely high irrigation application amounts. For example, in FIG. 4, the ETo readings are given in the top row for each day. The required watering amounts are given in the second row and are the same as the previous days ETo readings. The rolling-average is determined based on a four day rolling-average and therefore the rolling-average data, in this example, starts on the 20^{th} of August. If applications were only applied based on the required watering amount the highest application amount would be 0.29 inches of water (required watering amount on day 26). By using a four day rolling-average the highest application amount is 0.26 inches of water, which occurred on days 20, 21, and 29. Although a four day rolling-average is preferred, it is contemplated that a rolling-average of more than or less than four days may be used. Additionally, the rolling-average may be a weighted rolling average with greater emphasis put on some days than on other days.

The example in FIG. 4 is based on inches of water that are applied by the irrigation system. It should also be apparent that the water applied by the irrigation system can be set in any appropriate measure, including inches (or other linear units such as millimeters or centimeters), minutes (or other time units such as seconds or hours), and gallons (or other volume measurements such as liters, acre-inches), and so forth. Those skilled in the art will immediately recognize that these different measurements and units are interchangeable for irrigation systems.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An irrigation controller comprising a microprocessor programmed to automatically derive an irrigation schedule based at least in part on a rolling-average of required watering amounts.

2. The irrigation controller of claim 1, wherein the rolling-average is an average of four consecutive required watering amounts.

3. The irrigation controller of claim 1, wherein the irrigation schedule and required watering amounts are at least partly derived from ETo data.

4. The irrigation controller of claim 3, wherein the ETo data comprises potential ETo data.

5. The irrigation controller of claim 3, wherein the ETo data comprises estimated ETo data.

6. The irrigation controller of claim 3, wherein the ETo data comprises historical ETo data.
